(19) United States
(12) Patent Application Publication
(10) Pub. No.: US 2017/0127880 A1
(43) Pub. Date: May 11, 2017

(54) METHOD OF MAKING OUTDOOR FIREPLACES AND THE LIKE

(71) Applicant: Raymond Paulding, Palm City, FL (US)

(72) Inventor: Raymond Paulding, Palm City, FL (US)

(21) Appl. No.: 14/938,454

(22) Filed: Nov. 11, 2015

(51) Int. Cl. A47J 37/07; A47B 55/04; F16B 47/00

(52) U.S. Cl. CPC A47J 37/0759; F16B 47/003; A47B 55/04

(57) ABSTRACT

A method for off-site manufacture of prefabricated monolithic fireplaces etc comprising a plurality of concrete blocks; the method comprising the steps of constructing a first layer of blocks, providing a steel frame and securing the same to the blocks and to a second layer of blocks constructed atop the first layer, and constructing additional layers of blocks sequentially atop the second layer each block being adhesively secured to each of its adjacent blocks.

### BACKGROUND OF THE INVENTION

Outdoor fireplaces, grill units, bars and even complete outdoor kitchens have in the past been constructed on-site from concrete blocks and the like and have been generally satisfactory. Due in particular to the high labor costs of masonry workers, however, the overall expense involved in on-site construction is relatively high. It may also be difficult to maintain quality control in on-site construction resulting in a partial lack of structural integrity of the units and even in severe structural failure over time.

It is the general object of the present invention to provide an off site low cost method of prefabricating monolithic structures of high structural integrity and overall high quality for use in the construction of outdoor fireplaces and the like.

It is a further object of the invention to provide a method of making units of the type mentioned which include integral high strength metallic structural frames and steel reinforced sub-assemblies resulting in a high degree of structural integrity of the overall units.

### SUMMARY OF THE INVENTION

In fulfillment of the aforesaid objects and in accordance with the present invention, an off-site prefabricated structure of concrete blocks or the like is provided with a first or base layer or course of blocks outlining the perimeter configuration of the structure. A rust proof frame of high strength metallic construction is provided with a configuration substantially the same as the base layer of blocks and is fixedly secured to the base layer of blocks in supporting relationship therewith to maintain their relative positions with respect to each other. A plurality of additional layers or courses of blocks are then provided atop the base layer of blocks and each block is affixed to each of its adjacent blocks by an adhesive bonding material.

In a presently preferred form, the blocks of the first layer are somewhat wider than those of the second layer to provide a narrow substantially horizontal inwardly extending shelf around the perimeter of the structure. The structural frame is generally L shaped in cross sectional configuration with one leg arranged horizontally and resting atop the shelf and the other disposed adjacent the inner surface of the second layer of blocks. Preferably, the structural frame is both bolted to and secured adhesively to substantially all of the blocks in both the first and second layers of blocks.

While other high strength materials may be employed, the metallic frame is preferably constructed of structural strength steel with a rust proof coating. Various adhesives may also be used with a high strength masonry water-based bonding agent presently preferred.

On completion of each unit, it is transported by truck for on-site installation and various lifting devices may be employed for positioning the structures in their desired on-site locations. A fireplace, for example may require two structures one atop the other. Other units may require two or more structures assembled in various side-by-side arrangements etc.

### DESCRIPTION OF THE DRAWINGS

FIG. 1 of the drawings is a perspective view showing an outdoor fireplace comprising two (2) prefabricated structures of the present invention one mounted atop the other,

FIG. 2 is a perspective view showing a fireplace similar to the FIG. 1 fireplace but with wood storage box units on each side thereof,

FIG. 3 is a grill unit including storage compartments and a sink and employing two (2) prefabricated structures of the invention in side-by-side relationship,

FIG. 4. is a bar unit comprising two (2) structures of the present invention in side-by-side relationship,

FIG. 5 is a perspective view of a lower fireplace unit with the front portion thereof broken away,

FIG. 6 is a plan view of a prefabricated structure of the present invention showing a metallic frame member forming a part thereof, and

FIG. 7 is an enlarged fragmentary sectional view taken as indicated at 7,7 in FIG. 6 and showing a portion of the frame member.

### DESCRIPTION OF THE PREFERRED EMBODIMENTS

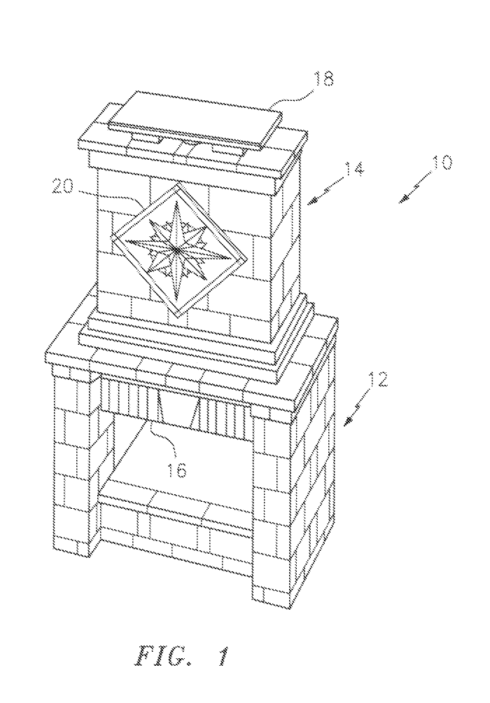

Referring particularly to FIG. 1 of the drawings, an outdoor fireplace is indicated generally at 10 with a lower unit 12 and an upper unit 14, the lower unit 12 having a conventional front opening 16 and the upper unit 14 having a cap 18 and a vertical through opening internally and which serves as a chimney for the lower unit. The fireplace is constructed of concrete blocks with aesthetically treated exposed surfaces and a decorative emblem 20 may be included on the face of the upper chimney unit 14.

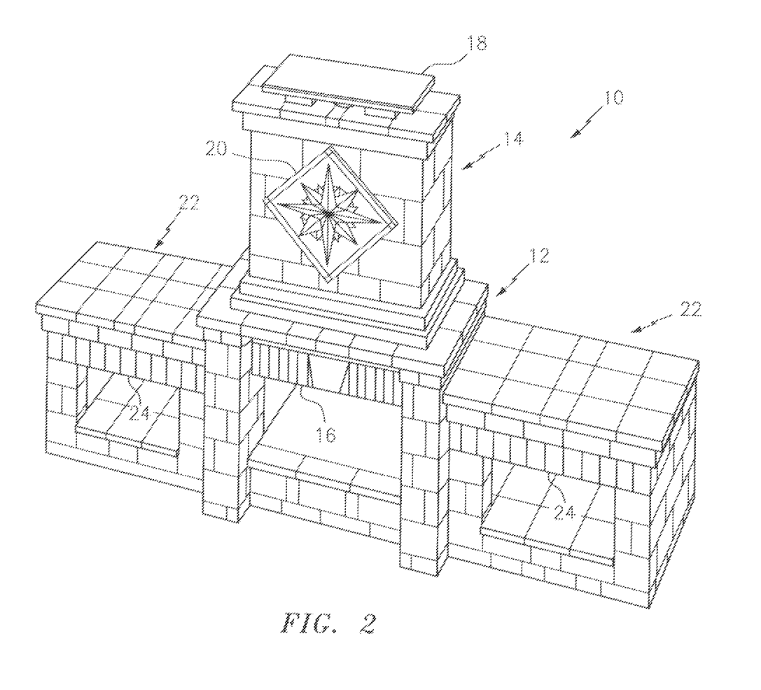

In FIG. 2, the FIG. 1 fireplace is shown in association with left and right hand wood storage units 22, 22. The wood storage units 22, 22 are of similar construction with aesthetically pleasing concrete blocks and each is provided with a front opening 24 readily accessible for the storage of wood to be used in the fireplace.

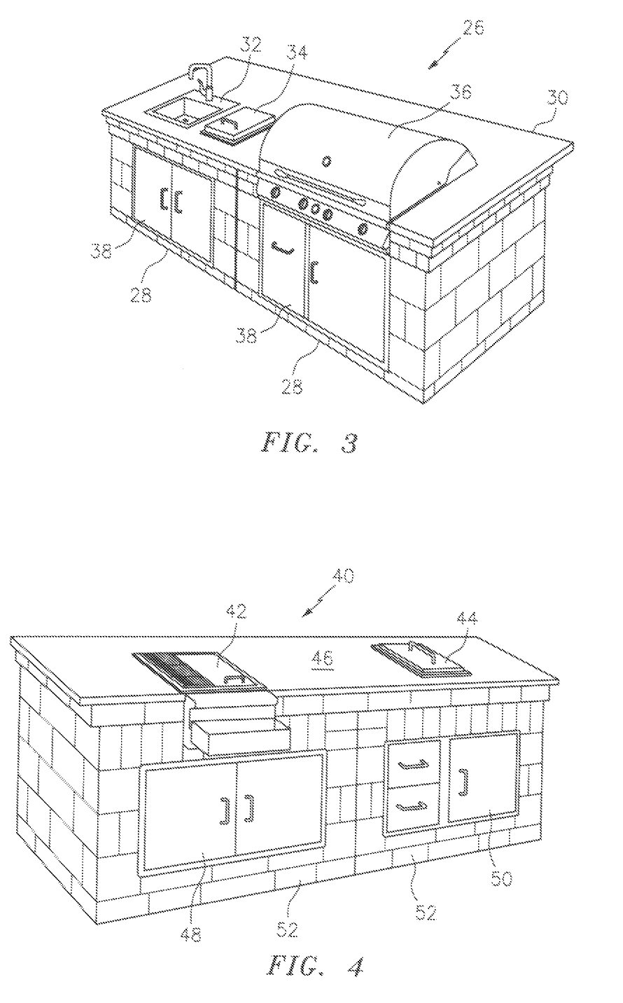

FIG. 3 illustrates a somewhat larger unit 26 which may comprise similar units 28, 28 in side-by-side adjacent relationship with a unitary top 30 mounted on both of the units 28, 28. A sink may be provided as at 32, with an adjacent storage compartment 34 and a covered grill unit 36 with further storage units 38 accessible through the front wall of the unit.

FIG. 4 shows a bar unit indicated generally at 40 with storage compartments 42, 44 accessible in a top counter member 46 and front storage units accessible through doors 48 and 50. The unit 40 may conveniently be constructed of a pair of similar units 52, 52 disposed in side-by-side relationship with the counter 46 arranged atop both units. compartments 42, 44 accessible in a top counter member 46 and front storage units accessible through doors 48 and 50. The unit 40 may conveniently be constructed of a pair of similar units 52, 52 disposed in side-by-side relationship with the counter 46 disposed atop both units.

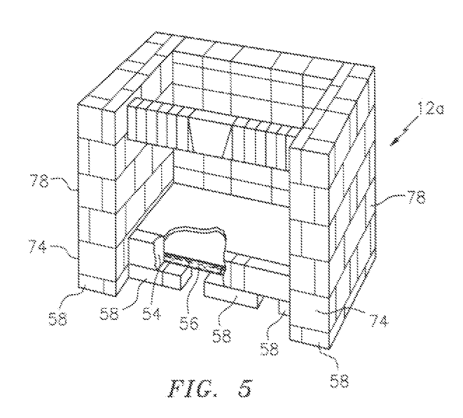

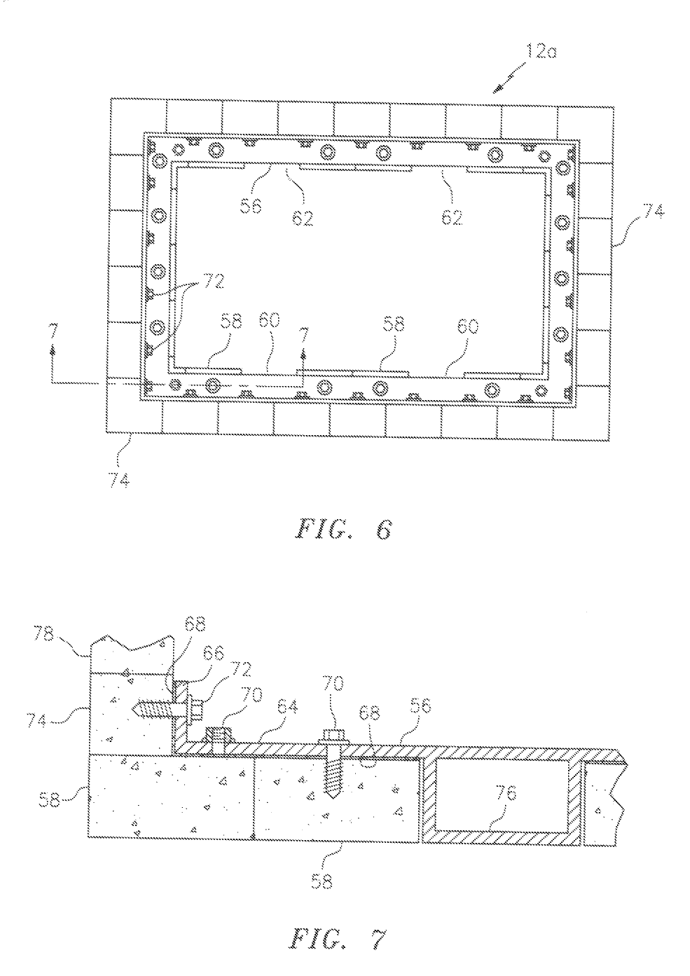

In FIG. 5 a lower fireplace unit 12a is shown with a portion of its front wall broken away at 54 to expose a portion of a metallic frame 56 better illustrated in FIGS. 6 and 7. The metallic frame 56 takes a rectangular configuration as best illustrated in FIG. 6 and is disposed atop a first layer or course of blocks 58, 58. The blocks 58, 58 are arranged in the desired configuration for the perimeter of a structural unit in the course of the fabrication of the unit. They may then be adhesively secured together.

The frame 56 is of a high-strength rust-proof metallic construction such as structural steel and preferably takes an L shape configuration in cross-section as best illustrated in FIG. 7 with a horizontal portion 64 and an integral vertical portion 66. The horizontal portion 64 is secured to the shelf portions of blocks 58, 58 of the first layer or course of blocks preferably by an adhesive 68 and bolts 70, 70. Similar bolts 72, 72 secure the structural member 56 to the blocks 74, 74 of a second layer or course of blocks disposed atop the blocks 58, 58 and somewhat narrower so as to provide a horizontal shelf for mounting the structural member 56 atop the blocks 58, 58. The vertical portion 66 of the structural member is secured to each of the blocks 74, 74 by bolts 72, 72 and by adhesive 68. Thus, the frame and the blocks of the first and second layers provide a sub-assembly and base of high integrity for the structural unit 12a.

A plurality of blocks 78, 78 arranged in vertically stacked relationship may be assembled in a desired number of layers or courses atop the second layer of blocks 74, 74 with each block adhesively secured to all adjacent blocks to provide a complete monolithic structure of high structural integrity.

From the foregoing, it will be apparent that a method has been provided for the off site construction of structural units of a high degree of structural integrity through the use of an efficient low cost production procedure.

1. A method for the off-site manufacture of prefabricated monolithic structures comprising a plurality of blocks formed of concrete or the like and used in constructing outdoor fireplaces, grill and countertop units, bars and the like; the method comprising the steps of constructing a base layer of blocks in a desired configuration representing the perimeter of a structure, providing a rust proof structural frame of high strength metallic construction having a configuration substantially the same as that of the base layer of blocks, fixedly securing the frame in supporting relationship with interior surfaces of the base layer of blocks, sequentially constructing additional layers of blocks atop the first layer of blocks and atop each other, and affixing each of the blocks in each of the additional layers of blocks to each of its adjacent blocks by means of a high strength adhesive bonding material.

2. A method as set forth in claim 1 wherein the structural frame is also fixedly secured in supporting relationship with interior surfaces of the blocks in a second layer of blocks.

3. A method as set forth in claim 2 wherein the blocks of the first layer are somewhat wider than those of the second layer to provide a narrow substantially horizontal inwardly extending shelf defined by the top surfaces of the first layer of blocks around the perimeter of the structure, and wherein the structural frame is generally L shaped in cross sectional configuration with one leg arranged horizontally and engaging and affixed to the top surfaces of the base layer of blocks and with an integral vertically engaging and affixed to adjacent vertical interior surfaces of the second layer of blocks.

4. A method as set forth in claim 3 wherein the structural frame is both bolted to and secured adhesively to substantially all of the blocks in both the first and second layers of blocks.

5. A method as set forth in claim 1 wherein a high strength masonry adhesive is employed in bonding the blocks to each other.

6. A method as set forth in claim 1 wherein an opening of substantial size is provided in a front sidewall of the structure so as to enable use of the same as a fireplace.

7. A method as set forth in claim 6 wherein a second structure similar to the first and having a vertical through opening is fabricated and is placed atop the first structure to serve as a chimney.

8. A method as set forth in claim 6 wherein a horizontal rust proof metallic header is provided and installed across the top of the fireplace opening with opposite end portions secured between vertically adjacent layers of blocks.

9. A method as set forth in claim 1 wherein a substantially horizontal cooking grill of rust proof metallic construction is provided and mounted in a structure.

10. A method as set forth in claim 9 wherein a second structure similar to the first is prefabricated and positioned adjacent and in close proximity to the first structure, and wherein a large unitary countertop is provided and positioned atop both the first and second structures, an opening being provided in the countertop member to receive the grill.

11. A method as set forth in claim 1 wherein a second structure similar to the first is prefabricated and positioned adjacent and in close proximity to the first, wherein a large unitary countertop is provided and positioned atop both the first and second structures, and wherein a sink is provided in one portion of the countertop.
